(19) United States
(12) Patent Application Publication
(10) Pub. No.: US 2010/0065767 A1
(43) Pub. Date: Mar. 18, 2010

(54) WHISKER ACTUATED FAUCET CONTROLLER

(75) Inventors: Peter A. Pubben, Calgary (CA); Gregory Vincent Browne, Victoria (CA); Chris Denny, Victoria (CA)

Correspondence Address: JACKSON WALKER, L.L.P., 112 E. PECAN, SUITE 2400, SAN ANTONIO, TX, 78205, US

(73) Assignee: TAPMASTER INCORPORATED, Calgary, AB (CA)

(21) Appl. No.: 12/527,662

(22) PCT Filed: Feb. 20, 2008
(86) PCT No.: PCT/CA2008/000311

§ 371 Date: Aug. 18, 2009

Related U.S. Application Data
(60) Provisional application No. 60/890,782, filed on Feb. 20, 2007.

(30) Foreign Application Priority Data
Oct. 16, 2007 (CA) PCT/CA2007/001832

(51) Int. Cl. F16K 31/44

(52) U.S. Cl. 251/231

(57) ABSTRACT

A faucet controller for operating a valve mounted in association with a faucet, having a joystick actuator mountable on the valve for movement between a normal at rest position and a valve operating position, and a whisker connected with the joystick for forcing the joystick actuator into the valve operating position.

### CROSS REFERENCE TO RELATED APPLICATIONS

This application claims priority to PCT application PCT/CA2008/000311, entitled “Whisker Actuated Faucet Controller,” filed Feb. 20, 2008 and published Aug. 28, 2008 as WO2008/101326 A1, which claims priority to PCT application PCT/CA2007/001832, filed Oct. 16, 2007, and U.S. Provisional Application 60/890,782, filed Feb. 20, 2007. All of the foregoing are incorporated herein by reference.

### FIELD OF THE INVENTION

The present invention relates generally to the actuation of a valve. More particularly, the present invention relates to the actuation of a valve using a body part or limb.

### BACKGROUND OF THE INVENTION

It has been amply demonstrated by a variety of studies and research that conventional hand operated faucets are a source of wasted water and energy and a cross contamination point for the spread of infectious diseases. Several devices have been developed and marketed to overcome these problems but all have some disadvantages. Mechanical foot pedal or knee operated faucets are expensive and often require extensive and costly modifications to plumbing and cabinetry. Infra-red sensor electrically operated faucets are costly to install, require an electrical outlet, may be erratic in operation and may permit cold and hot water cross flow. Foot pedal valves controlling the application of air pressure to water controlling valves are expensive and often difficult to install and require a compressed air source. Some devices attach to the spout of the faucet and although easily installed, they connect the cold and hot water supplies together, thereby permitting cross flow between them. Of these, ultrasound sensor electrically operated valves require batteries and are too bulky to comfortably adapt to many faucets. Other types operate by a foot control supplying fluid pressure through flexible tubing connected to a spout mounted valve. These tend to be untidy and cumbersome to operate. Examples of such devices are described and illustrated in U.S. Pat. No. 5,029,806, dated Jul. 9, 1991 granted to Chaung for a “Foot-Controlled Valve” and in U.S. Pat. No. 3,536,294, dated Oct. 27, 1970, granted to Rodrigues for a “Foot-Operated Control Valve Attachment Device for Water Faucets.”

Pubben, U.S. Pat. No. 5,505,227, discloses a “hands free” system for controlling the flow of water to a faucet. The system includes a pilot valve which provides pilot water of controlled pressure to operate diaphragm valves in a control block. The valves in the control block may be respectively connected between hot and cold water supply lines and a faucet. The pilot valve may be located in a position where it can be operated by a user's knee or elbow, or in another location where foot operation is possible.

U.S. patent application Ser. No. 10/456,085 (Publication No. 2004/0200987) by Houghton discloses a hands free water faucet controller device to regulate the flow rate and temperature mix using a foot controllable actuator.

It is, therefore, desirable to have a simple valve actuator operable by either hip, arm, elbow, foot or knee etc. and easily installed in association with a cabinet. It is further desirable to have an actuator simple in construction, reliable, economical and adjustable to the height of different cabinet toe boards.

### SUMMARY OF THE INVENTION

It is an object of the present invention to obviate or mitigate at least one disadvantage of previous faucet controller assemblies.

In a first aspect, the present invention provides a faucet controller for operating a valve mounted in association with a cabinet, having mounting means for mounting the valve to the cabinet, a joystick actuator mountable on the valve for movement between a valve operating position and a normal at rest position, and a whisker connected with the joystick for forcing the joystick actuator into the valve operating position.

In a first aspect the present invention provides a faucet controller for operating a valve mounted in association with a faucet, including a joystick actuator connected with the valve for movement between normal at rest position and a valve operating position; and a whisker connected with the joystick actuator for forcing the joystick actuator into the valve operating position.

Preferably the joystick actuator comprising a disk retained within a disk housing, the disk adapted to reciprocate between a normal at rest position and a valve operating position upon activation of the whisker.

Preferably the disk housing includes a joystick guide adapted to restrict the movement of the joystick to a single plane. Preferably, the joystick guide includes a channel formed within the disk housing and a corresponding protuberance extending from the surface of the disk.

Preferably the disk is operatively associated with a valve piston to operate the valve, wherein rocker movement of the disk by way of force on the whisker axially displaces the valve piston to activate the valve.

Preferably, the disk has a curved face. Preferably, the disk has a tapered outer surface.

Preferably the whisker includes a flexible elastic member. Alternatively, the whisker includes a substantially rigid member. Alternatively, the whisker includes a composite member, a first portion of the composite member including a substantially rigid member and a second portion of the composite member including a flexible elastic member.

Preferably the elastic material is selected from the group of plastic, rubber, or spring steel. Preferably, the whisker includes a substantially linear spring. Preferably, the whisker includes a coiled spring.

Preferably, the whisker includes a shaped member. Preferably, the shaped member is selected from the group of a beaver tail, paddle, arm, cylinder, cone, curved member, spiral member, sinusoidal member, or zigzag member.

Preferably, a guard is fixed to an outer end of the whisker.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of a first exemplary embodiment of a faucet controller in accordance with the present invention shown associated with a cabinet;

FIG. 2 is a perspective view of a 3-way valve of the faucet controller of FIG. 1;

FIG. 3 is a cross section of the 3-way valve of FIG. 2;

FIG. 4 is a perspective view of the faucet controller of FIG. 1;

FIG. 5 is a perspective view of an alternate embodiment of a whisker of the present invention;

FIG. 6 is a perspective view of a disk/joystick actuator of the faucet controller of FIG. 1; and

FIG. 7 is a perspective view of an alternative embodiment of a whisker of the present invention.

### DETAILED DESCRIPTION

Generally, the present invention provides a faucet controller for controlling the flow of a fluid through a valve. The faucet controller is particularly suitable for valves of the type disclosed in U.S. Pat. No. 5,505,227, but is also applicable to other types of valves, particularly 3-way pilot valves that can be actuated by the depression of a piston or button.

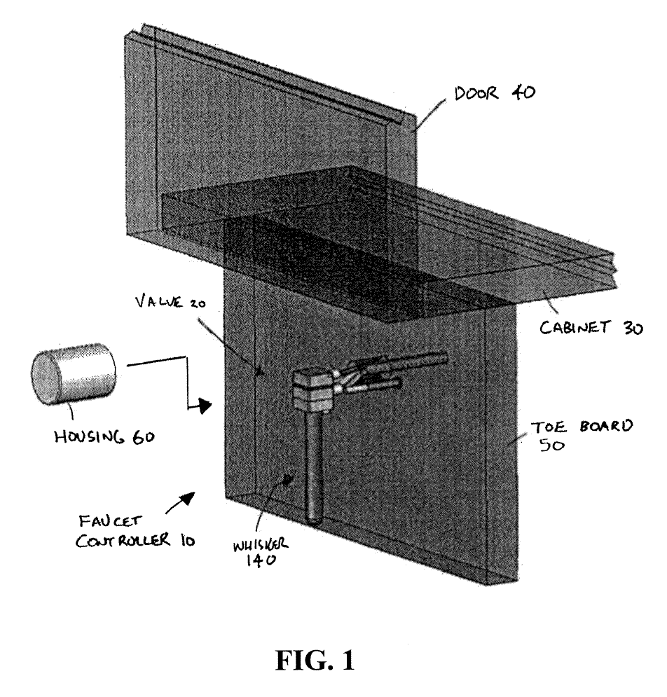

Referring to FIG. 1, a faucet controller 10 in accordance with the present invention as shown in the attached drawings is intended for operation of a valve 20 mounted to a cabinet 30 with a door 40 and a toe board 50 by moving a whisker 140 between a normal, at rest, position and a valve actuating position. The faucet controller 10 is shown mounted to the toe board 50, but the faucet controller 10 may alternatively mounted, such as to the cabinet 30, the door 40, the floor or wall (not shown) or otherwise mounted to or near the fixture. A housing 60 shields the valve 20, for example from physical damage.

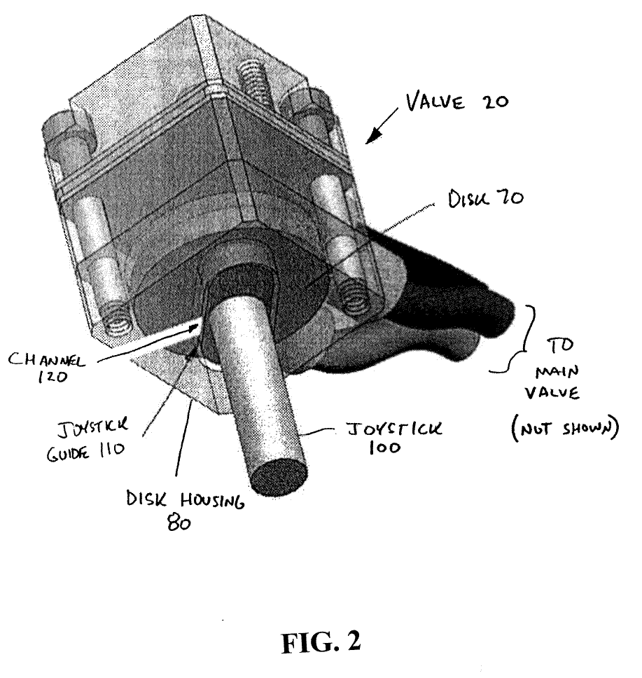

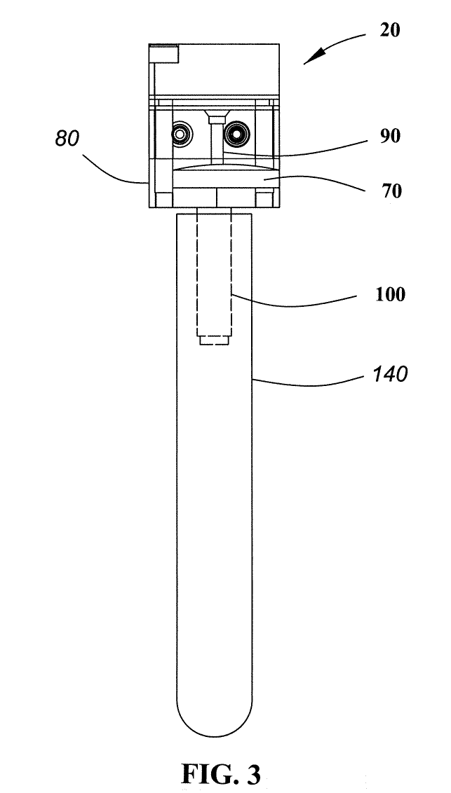

Referring to FIGS. 2 to 3, the valve 20 is operable by a disk 70 mountable on the valve 20 for pivotal reciprocation between a normal at rest position and a valve operating position. The valve 20 is preferably biased into the normal at rest position. The valve 20 preferably is operated by a valve piston 90 reciprocal in a disk housing 80. The disk 70 is housed within the disk housing 80 and operatively associated with the valve piston 90 to activate the valve 20 such that pressure on the disk 70 by way of movement of a joystick 100 axially displaces the valve piston 90 to activate the valve 20.

Referring to FIG. 2, the disk housing 80 includes a joystick guide 110 in the form of an elongate channel 120. The joystick guide 110 allows movement of the joystick 100 in a longitudinal direction (substantially parallel to the channel 120). However, the joystick guide 110 is optional and the faucet controller 10 may include a disk 70/joystick 100 that are unconstrained, and operable in a full 360 degree direction.

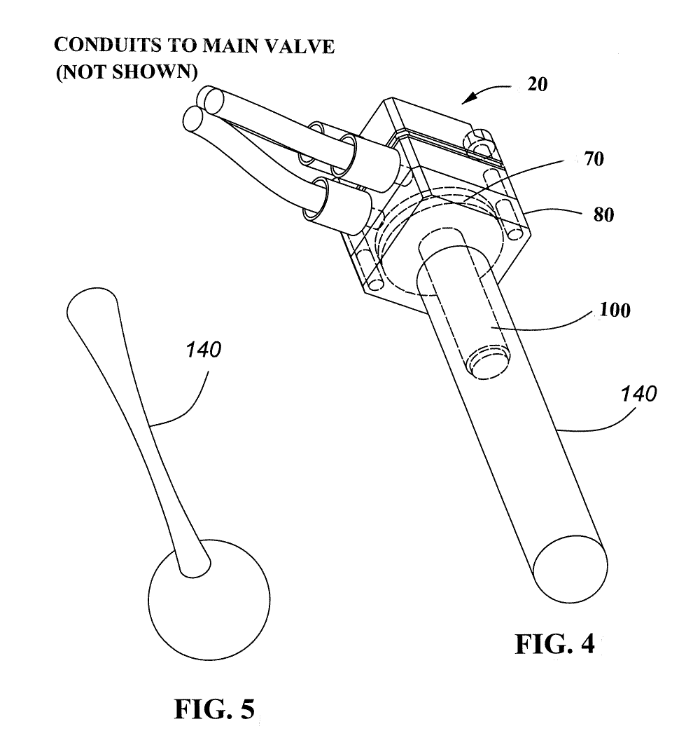

Referring to FIGS. 4 and 5, a member 130 in the form of a whisker 140 is fixedly attached to the joystick 100, whereby movement of the whisker 140 translates into movement of the joystick 100. Preferably, the whisker 140 is constructed of an elastic material, such as a plastic or rubber or spring steel (e.g. straight or coiled or curved etc.). Alternatively, the whisker 140 may be constructed of a relatively rigid material, such as a plastic or stainless steel, or a combination of elastic and relatively rigid materials. Regardless of the materials chosen, preferably, the whisker 140 is provided in at least a partially elastic configuration to provide operational comfort and feedback to a user of the faucet controller 10 as well as facilitate easier cleaning around the whisker 140.

While shown as a relatively straight, elastic member, the whisker 140 may function in a wide variety of configurations, shapes and sizes. For example, but not limited to, a beaver tail, paddle, arm, cylinder, cone, curved, spiral, sinusoidal, zigzag etc. and may be long, short, slender, narrow, wide etc.

Depending on the material or combination of materials chosen, the whisker 140 may end up being very slender, for example if constructed out of straight spring steel. In such cases, and optional guard 170 in the form of a enlarged sphere or disk may be added to the end of the whisker 140 to improve visibility and improve ergonomics.

The whisker 140 may be identified by color to designate the fluid delivered by the faucet (not shown) being controlled by the faucet controller 10, for example red for hot, blue for cold, red and blue for mix, or otherwise marked. The whisker 140 may be made in a variety of configurations. Preferably, as shown in FIG. 4, the whisker 140 is an elongate, relatively slender member. However, one skilled in the art would recognize that the specific configuration of the whisker 140 may be adapted to the particular environment and style or decor of the installation. The whisker 140 may extend substantially to the floor (not shown) or may provide a gap (not shown) between the floor (not shown) and the whisker 140.

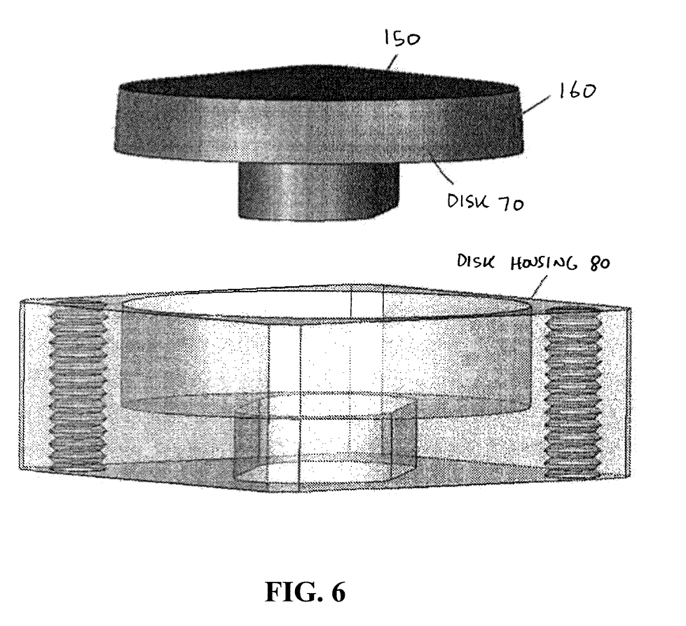

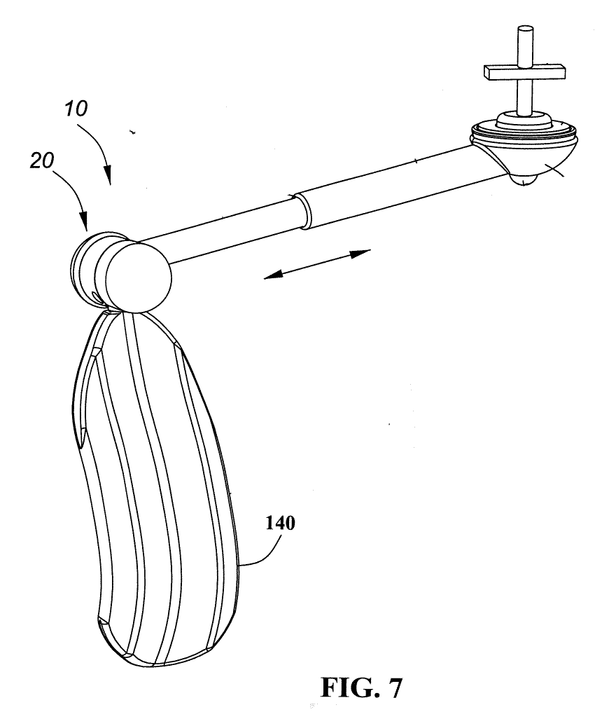

Referring to FIG. 6, the disk 70 may include a curved face 150 distal to the joystick 100 (proximate the valve piston 90) and a tapered outer surface 160.

Referring to FIG. 7, the faucet controller 10 of the present invention is shown with the valve 20 mounted on an arm extending from a mount of the type suitable for use with a carrier arm mounting hole or holes of a sink, basin, or other fixture. As shown, the whisker 140 may be a beaver tail.

Referring to FIG. 1, although a single installation of the faucet controller 10 is shown, it is obvious to one skilled in the art that a plurality of installations of the faucet controller 10 are included in the present invention, for example, two in a hot/cold configuration, three in a hot/mix/cold configuration, two in a soap/water configuration, two in a solvent/air configuration, four in a fluid a/b/c/d configuration etc.

Referring to FIG. 1, although installation in association with a toe board 50 is shown, the faucet controller 10 (or a plurality of the faucet controllers 10) may be installed in a variety of configurations, elevations, orientations, etc. For example, but not limited to, installations suitable for operation of the faucet controller 10 by activation by a user's finger, hand, arm, elbow, shoulder, hip, leg, knee, calf, foot, toe etc.

In operation, application of pressure to the whisker 140 via a user's finger, hand, arm, elbow, shoulder, hip, leg, knee, calf, foot, toe etc. or other means causes movement of the joystick 100, thus causing pivotal movement of the disk 70 within the disk housing 70 to depress the valve piston 90, causing the valve 20 to move between a normal at rest position and a valve operating position. Release of the pressure on the whisker 140 allows the joystick 100 and the valve 20 to return to the normal at rest position.

In operation, to facilitate cleaning of the toe board 50 or the back side of the whisker 140, the whisker 140 may be removable from the joystick 100 (and/or may be user replaceable).

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

1. A faucet controller for operating a valve mounted in association with a faucet, comprising:
a. a joystick actuator connected with the valve for movement between a normal at rest position and a valve operating position; and
b. a whisker connected with the joystick actuator for forcing the joystick actuator into the valve operating position.

2. The faucet controller of claim 1, the joystick actuator comprising a disk retained within a disk housing, the disk adapted to reciprocate between a normal at rest position and a valve operating position upon activation of the whisker.

3. The faucet controller of claim 2, the disk housing having a joystick guide adapted to restrict the movement of the joystick to a single plane.

4. The faucet controller of claim 3, the joystick guide comprising a channel formed within the disk housing and a corresponding protuberance extending from the surface of the disk into the channel.

5. The faucet controller of claim 2, the disk operatively associated with a valve piston to operate the valve, wherein rocker movement of the disk by way of force on the whisker axially displaces the valve piston to activate the valve.

6. The faucet controller of claim 2, the disk having a curved face.

7. The faucet controller of claim 2, the disk having a tapered outer surface.

8. The faucet controller of claim 1, the whisker comprising a flexible elastic member.

9. The faucet controller of claim 1, the whisker comprising a substantially rigid member.

10. The faucet controller of claim 1, the whisker comprising a composite member, a first portion of the composite member comprising a substantially rigid member and a second portion of the composite member comprising a flexible elastic member.

11. The faucet controller of claim 8, the elastic material selected from the group of plastic, rubber, and spring steel.

12. The faucet controller of claim 2, the whisker comprising a substantially linear spring.

13. The faucet controller of claim 2, the whisker comprising a coiled spring.

14. The faucet controller of claim 2, the whisker comprising a shaped member.

15. The faucet controller of claim 14, the shaped member selected from the group of a beaver tail, paddle, arm, cylinder, cone, curved member, spiral member, sinusoidal member, or zigzag member.

16. The faucet controller of claim 2, further comprising a guard fixed to an outer end of the whisker.
